(19) United States
(12) Patent Application Publication
(10) Pub. No.: US 2017/0322634 A1
(43) Pub. Date: Nov. 9, 2017

(54) KEYBOARD KEY WITH USER-CONFIGURABLE TYPING FORCE

(71) Applicant: Dell Products, LP, Round Rock, TX (US)

(72) Inventor: Jason S. Morrison, Cedar Park, TX (US)

(73) Assignee: Dell Products, LP, Round Rock, TX (US)

(21) Appl. No.: 15/150,323

(22) Filed: May 9, 2016

(51) Int. Cl. G06F 3/02; G06F 1/16

(52) U.S. Cl. CPC G06F 3/0216; G06F 1/1664; G06F 1/1671

(57) ABSTRACT

A modular display monitor system includes an interchangeable display panel with a panel interface and an interchangeable connector module that has a connecting dock and a connector for interfacing with the panel interface. A user-configurable key comprising a key support mechanical linkage having at least one hinge mounted to a key support surface, a rocker panel operatively coupled to the key support mechanical linkage and including a ferromagnetic portion, a magnet and a magnet holding plate slidably disposed along the key support surface. The magnet holding plate is adjusted via a magnet holding plate position adjuster for sliding the magnet holding plate to move the magnet with respect to a pivot of the rocker panel.

### FIELD OF THE DISCLOSURE

This disclosure relates generally to information handling systems, and more particularly relates to keyboards with configurable keys for use with information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

An information handling system may include a large number of individual servers and associated storage and peripheral devices. Among the peripheral devices, typically an information handling system includes a keyboard for receiving user input information from the user to the information handling system. Keyboards may be of a variety of types including a scissor switch keys, dome switch keys, membrane keyboards, bucking spring keyboards, virtual keyboards and the like.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a diagram illustrating an information handling system in accordance with an embodiment of the present disclosure;

FIG. 2 is a diagram illustrating a configurable key in accordance with an embodiment of the present disclosure;

FIG. 3 is a diagram illustrating a configurable key in a configurable keyboard system in accordance with a specific embodiment of the present disclosure;

FIG. 4 is a diagram illustrating portion of a configurable keyboard system in accordance with a specific embodiment of the present disclosure;

FIG. 5 is a graphical diagram illustrating adjustments of key force for keystrokes of a configurable keyboard in accordance with at least one embodiment of the present disclosure; and

FIG. 6 is a diagram illustrating a general information handling system in accordance with at least one embodiment of the present disclosure.

### DETAILED DESCRIPTION OF DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

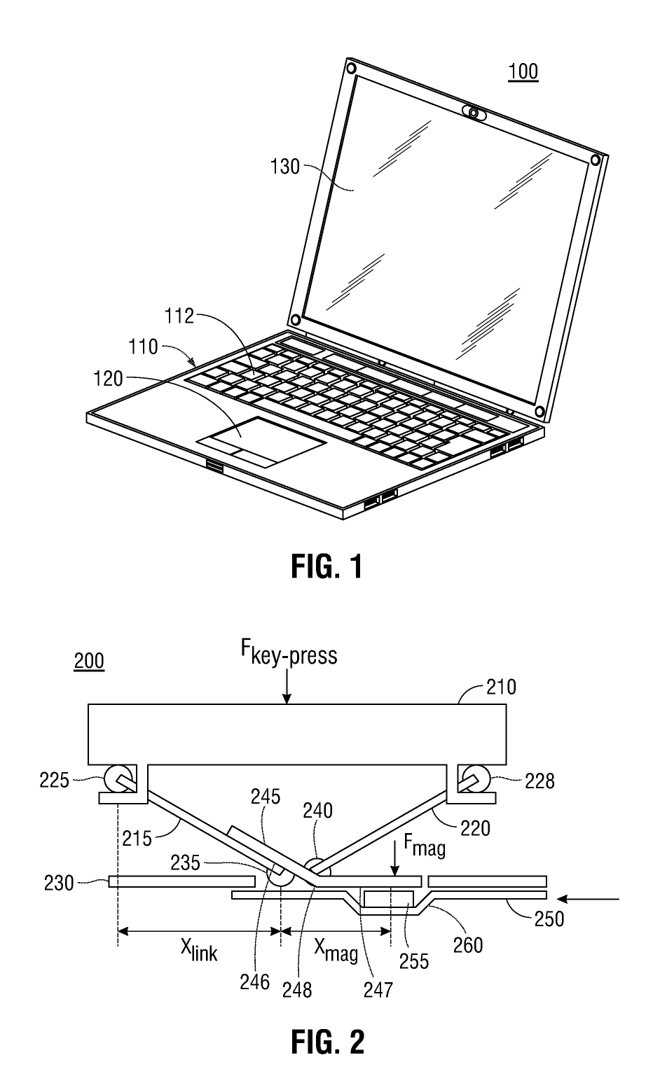

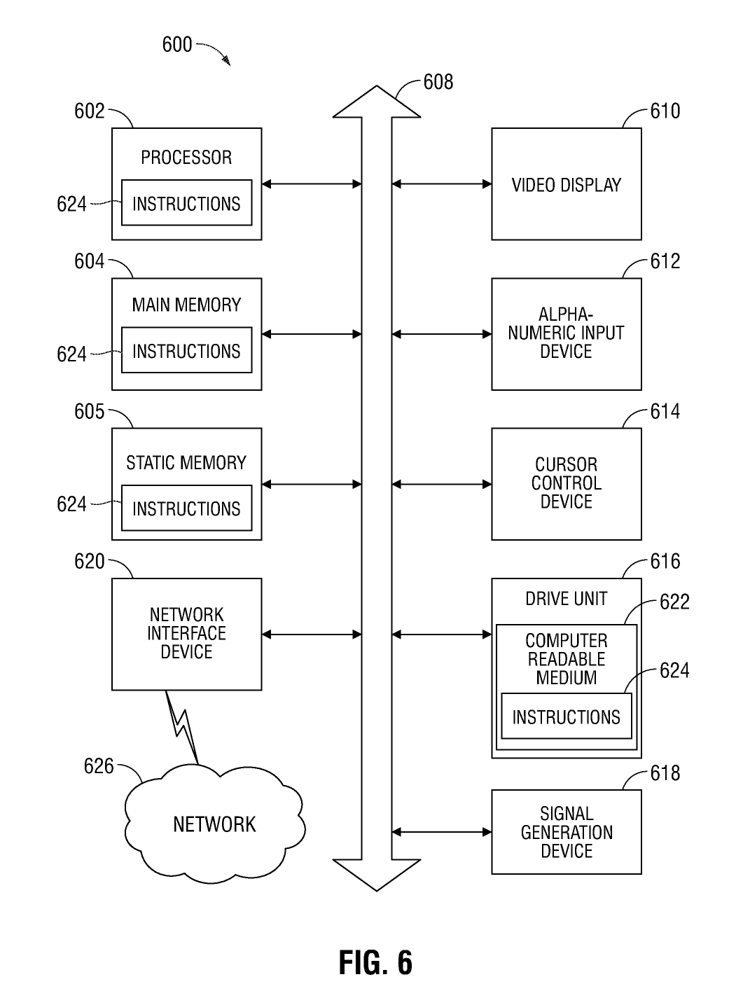

FIG. 1 illustrates an information handling system 100 used with a user-configurable keyboard 110 having one or more user-configurable keys 112 in accordance with at least one embodiment of the present disclosure. Keyboard 110 is configurable with respect to typing feel. Adjustment of keyboard 110 is available for key force involved in keystrokes during typing. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile information handling system such as a smartphone or table computer, a consumer electronic device, a network server or storage device, a switch router or other network communication device, or any other suitable device and may vary in size, shape, performance, functionality, and price. The shown example information handling system 100 is a laptop computer, but a variety of information handling systems are contemplated for use with a user-configurable key press force keyboard 110. In one example embodiment, the keyboard 110 may include a keyboard with retractable keys. The information handling system 100 may include memory, one or more processing resources such as a central processing unit (CPU) or hardware or software control logic. The information handling system 100 may further include video processing resources such as a graphics processing unit (GPU) or chipset and a graphics interface. Additional components of the information handling system may include one or more storage devices, one or more communications ports for communicating with external devices as well as various input and output (I/O) devices, such as a keyboard 110, a mouse, a touchpad 120 and a video display 130. The information handling system may also include one or more buses operable to transmit communications between the various hardware components. Further detail of an illustrative embodiment of the information handling system may be found below in the description of FIG. 6.

Referring now to FIG. 2, an example embodiment of a user-configurable key 200 is illustrated. Variations on key support structures used with keyboards are contemplated as differentiations for various embodiments. In the embodiment of FIG. 2, user-configurable key 200 includes a key-cap 210 upon which a key press force (F_{key-press}) is applied for actuation of the key. The F_{key-press} is a force applied for actuation of a keystroke during typing to actuate a key switch (not shown) for a key. User configurable key 200 of the present embodiment further includes a key support mechanical linkage that is a butterfly key support structure including two butterfly linkage portions 215 and 220. In other embodiments, a key support mechanical linkage may be a scissor-type key support structure with two scissor linkage portions. It is understood that other key support mechanical linkages may be used with the present disclosure in forming the user-configurable key in different embodiments.

Butterfly linkage portion 215 is hinged in the present embodiment at joint 235. Butterfly linkage portion 220 is hinged at joint 240. Joints 235 and 240 may operatively connect the butterfly linkage portions 215 and 220 to a keyboard support plate 230 or other support structure for the keyboard. In an example embodiment, the joints 235 and 240 are fixed joint points that do not move laterally, but hinge or allow angular rotation movement of the butterfly key support. As is understood, scissor linkages or other key support mechanical linkages may also be operatively connected via joints or contact points between a key cap and a keyboard support plate 230 or other support structure for the keys. For example, dome switch key support structures or spring based key structures may link a keycap 210 to a keyboard support plate 230.

Butterfly linkage portion 215 may further be operatively connected to keycap 210 at a second joint 225. Second joint 225 may be a floating joint in an example embodiment that may shift laterally along keycap 210 to allow angular rotation movement of the butterfly linkage portion 215 as the key cap is depressed. Similarly, butterfly linkage portion 220 may further be operatively connected to keycap 210 at another joint 228 as well. Joint 228 may also be a floating joint in some embodiments allowing lateral movement along the keycap 210 to allow for angular rotation movement of the butterfly linkage portion 220 when the keycap is depressed. It is understood that only one joint for each of the butterfly linkage portions 215 and 220 may be fixed or neither may be fixed. In some embodiments, joints 225 and 228 may be fixed laterally while joints 240 and 245 may be floating joints.

In an embodiment, the key support structure, such as the butterfly key support structure 215, 220, is operatively connected to a rocker panel or rocker strip 245. For purposes herein, a rocker panel 245 may refer to a strip, panel, or other material forming an obtuse angle on one side between to surfaces 246 and 247 along a side of the rocker panel 245. The two surfaces 246 and 247 of the obtuse angle are formed about a pivot 248 of the angle which forms a rocker structure. In an example embodiment, rocker panel 245 is a strip of material that is has at least one portion that is of ferromagnetic material for interaction with a magnet 255 slidably disposed in a magnet holding plate 250 along the keyboard support plate 230 and the rocker panel 245. Magnet holding plate 250 may also be referred to as a magnet holding tray in some aspects. In a further example embodiment, the rocker panel 245 may have a plurality of portions of ferromagnetic material on the surfaces 246 and 247 on either side of a pivot point 248. In yet another embodiment, the rocker panel 245 is made of a strip or panel of ferromagnetic material such as magnetic steel. The surfaces of the rocker panel 245 on either side 246 and 247 of the pivot 248 may be disposed to provide a bistable rocking motion along the keyboard support plate 230 during keystrokes or retraction.

Side 246 of rocker panel 245 may be operatively connected to butterfly linkage 215 such that when keycap 210 is depressed and butterfly linkage 215 angularly rotates along fixed joint 235, force or pressure is applied to side 246. It is understood that orientation of rocker panel 245 may be reversed such that side 247 is operatively attached to butterfly linkage 247. The operative connection may be via mechanical means such as a snap-fit attachment, a clamp or screw, a sleeve type of interface, or via other mechanical means understood by those in the art. Adhesive or other attachment means may be used to attach rocker panel 245 to either butterfly linkage 215 or 220 in an embodiment. It is also understood that rocker panel 245 may be attached instead to a scissor-type key support structure or to another key support structure in some embodiments. In some example aspects, it is understood that a rocker panel may need to be shifted as to location under the user-configurable key along with the magnet location to achieve a variation on the embodiment shown in FIG. 2. Other key support structures such as those described above are contemplated as well to form embodiments as would be understood in the art. A rocker panel 245 location shift may accommodate an operative connection between the rocker panel and the key support mechanical linkage used in various embodiments.

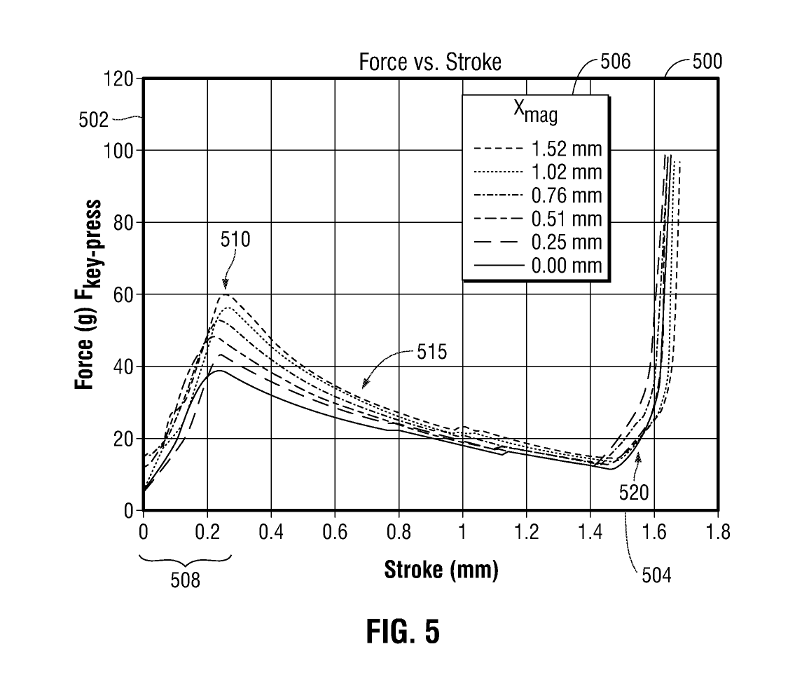

The ferromagnetic material of side 247 of rocker panel 245 may be within magnetic field of magnet 255 such that side 247 of rocker panel 245 is held by magnetic attraction in a down position while the key is in an up position. F_{mag} illustrates the magnetic force applied to a ferromagnetic side 247 of rocker panel 245. As F_{key-press} is applied, F_{mag} must be over come as the keystroke progresses during typing or other use of the key. The key-press force required to actuate the keys on a keyboard relates to the typing feel and the responsiveness of the keyboard. Several examples of the key-press force and keystroke actuation are shown and described further below with respect to FIG. 5.

Upon actuation of the keystroke, rocker panel 245 may deflect somewhat and then pivot about pivot point 248 when F_{mag} is overcome. It has been determined that the location of the magnet under the rocker panel 245 along a side 247 and in relative proximity to the pivot 248 or, similarly within a relative distance to hinge joint 235 of butterfly linkage 215, impacts the force to overcome F_{mag} during typing. The F_{key-press}required to overcome F_{mag} due to the lever aspect of the application of F_{mag} on side 247 reduces as magnet 255 is moved closer to the pivot 248. For example, as the distance x_{mag} decreases relative to the distance xₗᵢₙₖ or the distance along the butterfly linkage travel path, the amount of key press force necessary to overcome F_{mag} also decreases affecting the typing feel of the key. The distance x_{mag} also decreases relative to pivot 248 and to joint hinge 235 in that the magnet is moved closer to pivot 248 along the side 247 of the surface of rocker panel 245 by the same lateral actuation of the magnet 255.

Magnet 255 is operatively connected to a magnet holding tray 250 which may be slidably actuated laterally along keyboard support plate 230 to move the magnet 255 laterally along x_{mag}. Actuation of magnet holding plate 250 along keyboard support plate 230 may be done via mechanical techniques or systems as described further below. The actuation of magnet holding plate 250 may further be controlled by an electric motor or other electro-mechanical engagement system understood in the art to move magnet holding plate at sufficient distances to adjust the typing force and typing feel of user-configurable key 200.

It is understood that magnet 255 may be operatively connected to magnet holding plate 250 by a variety of techniques. In an embodiment, magnet 255 may be mechanically fit into cut-outs or mechanical clamping structures to fix a magnet within magnet holding tray 255. In another example embodiment, magnet 255 may fit into a depression or trough 260 in the magnet holding tray 250. In one example embodiment, magnet 255 may be press-fit into trough 260. Additionally, magnet 255 may also be adhesively bonded to magnet holding plate 250 in some embodiments. For example, adhesive bonding may be used to operatively connect magnets into trough 260.

Magnet holding tray 250 may comprise a non-magnetic material in some embodiments so as not to interfere with the magnetic force F_{mag} exerted by magnet 255 on rocker panel 245 during typing force adjustment over time. In an embodiment, a non-magnetic or reduced-magnetic metal may be used for magnet holding plate 250. In other embodiments, types of plastic or other suitable material may be used for magnet holding tray 250. It is understood that magnet holding tray 250 may not be a solid material tray under one or more user-configurable keys 200 and may instead by a lattice or other form of connected sheet material with openings or transparency. The form of magnet holding tray 250 may be modified to accommodate key backlighting, key actuation requirements, or other structural necessities to construct the user-configurable key with features commonly available or desired with a user-configurable key and as is understood in the art. For example, other key support mechanical linkage types may alter the magnet holding plate 250.

In an aspect, the key 200 of FIG. 2 may be retractable. Substantial movement of magnet holding plate 250 and, thus, magnet 255 with respect to the pivot 248 of rocker panel 245 will cause the key retraction. As magnet 255 slides under side 246 of rocker panel 245 it will exert a magnetic force on side 246 if that side has a portion that is ferromagnetic. Exertion of magnetic force on side 246 will cause compression of the key support structure on mechanical linkage portion 215 and retract keycap 210 downward. Thus, the system described above for a user-adjustable key may also be used with a retractable key system in some embodiments. A magnet plate position actuator mechanism may be used with the magnet plate 250 that provides for both fine tune adjustment of key press force as well as permit retractability of the keys. For example, a worm screw or rack and pinion actuator mechanism may be used that has a settable stopping point when keys are returned to the up position from retraction. That return point may be fine-tuned by adjustment under the current disclosure to provide for user-adjustable typing feel according to embodiments as described herein.

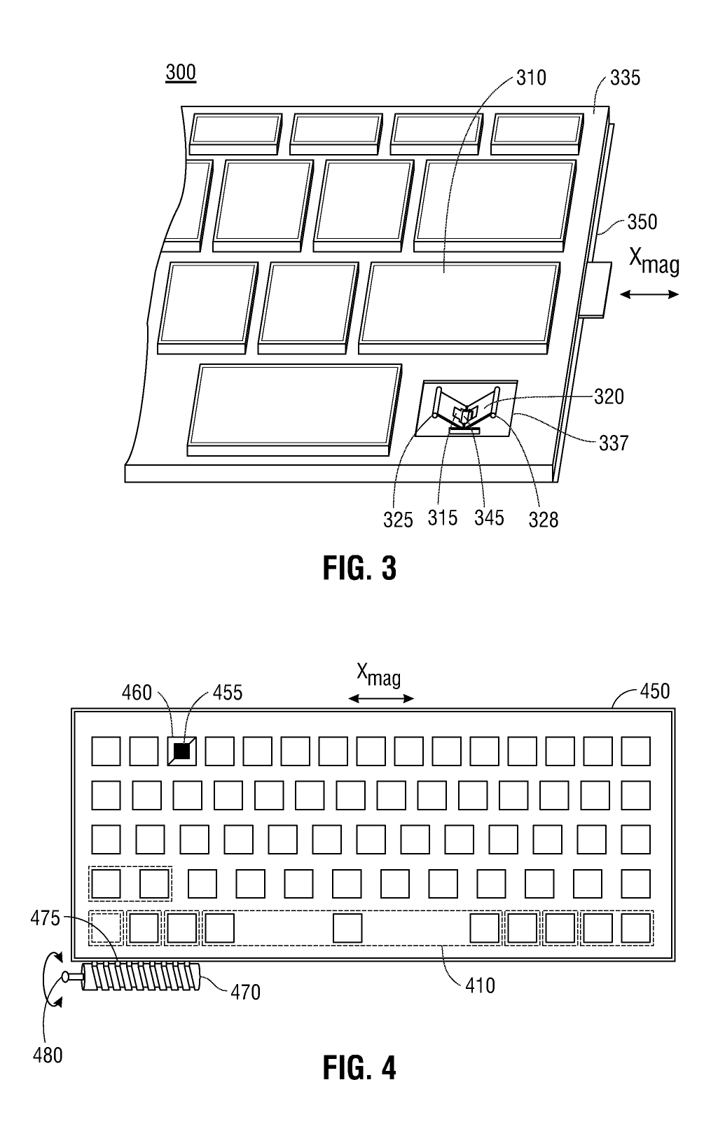

FIG. 3 illustrates an example embodiment of a user-configurable keyboard 300. It is understood that only a partial keyboard is illustrated and keyboards of a wide variety of formats are contemplated. User-configurable keyboard 300 includes a plurality of user configurable keys and a keyboard case 335. The user-configurable keys include keycaps such as 310. One user-configurable key is illustrated without a keycap 310. Variations on key structures used with keyboards are contemplated as differentiations for various embodiments as described above. The user-configurable key without keycap of the present embodiment further includes a butterfly key support structure including two butterfly linkage portions 315 and 320. In other embodiments, a scissor-type key support structure may be used with two scissor linkage portions. Butterfly linkage portions 315 and 320 are hinged in the present embodiment at a joint at the bottom of the two butterfly linkage portions within a cut-out 337 of keyboard case structure 335. Cut-out 337 may be made for individual keys or for a plurality of keys closely spaced in various embodiments. A key support structure (not shown) as described above for FIG. 2 may be used to support the butterfly key support structure and the two butterfly linkage portions 315 and 320 portions from below the keyboard case structure 335.

Butterfly linkage portions 315 and 320 are also shown with second joints 325 and 328 respectively to enable operative connection to a keycap. Butterfly linkage portions 315 and 320 move with angular rotation about the hinged at joint at the bottom of linkage portions 315 and 320 in some embodiments as a key cap is depressed by a user. Shown in FIG. 3, rocker panel 345 is connected to butterfly linkage portion 315. As is understood, scissor linkages may also be operatively connected via joints between a key cap and a keyboard support plate or other support mechanical linkage structure may be used for the user-configurable keys.

The user-configurable key of the present embodiment further includes an operatively connected rocker panel or rocker strip 345. The rocker panel is connected to at least one of the butterfly linkage portions 315 and 320 of butterfly support structure. The rocker panel 345 may refer to a strip, panel, or other structure of at least partial ferro-magnetic material forming an obtuse angle on one side that may pivot about or near a center point of the key support structure. In an example embodiment, the rocker strip 345 may pivot bi-stably about a point at or near to the bottom joint of butterfly linkage portions 315 and 320. In other embodiments, the pivot may be at a different location depending upon the type of mechanical linkage key support structure used.

A key support plate is disposed below keyboard case 335 in an embodiment. Also shown in the example of FIG. 3 is a magnet holding plate 350 slidably disposed under keyboard case 335. In an example embodiment, magnet holding plate 350 may slide laterally along x_{mag} as shown. Magnet holding plate 350 may be disposed along a key support plate (not shown) in example embodiments. As described further below, the magnet holding plate 350 holds magnets for magnetic engagement with rocker panels 345 under the user-adjustable keys and provides for lateral shift of the magnets with respect to the pivot points of rocker panels 345. The adjustment of the magnets with respect to the pivot of the rocker panels 345 will affect the key force for depressing the butterfly support structure of the keys as described above. The key press force is applied over the bistable rocking motion of the rocker panel 345 as against the magnetic force applied one or the other side of the rocker panel depending on the configuration.

FIG. 4 illustrates an example embodiment of a magnet holding plate 450. Magnet holding plate 450 is shown with a plurality of troughs such as shown at 460. Magnets such as 455 may be disposed within troughs 460. Adhesive may be used in some embodiments to secure magnet 455 within trough 460. Other techniques for operative connection of the magnet to the magnet holding tray may also be employed in some aspects. Cut-outs in magnet holding plate 450 may be used to secure magnets 455 such that the magnets 455 and cut-outs mechanically snap fit together or are clamped together in an example embodiment.

FIG. 4 also illustrates, by dashed lines, example locations of where some keycaps 410 may sit with respect to the magnet holding plate 450. Magnet holding plate 450 may slide laterally along x_{mag} with respect to keycaps 410. It is understood that magnet holding plate 450 may also slide laterally with respect to key support structures (not shown) as described in other embodiments above.

Magnet holding plate 450 may be moved laterally via a positioning adjustment actuator 470. An example embodiment of a magnet holding plate position adjustment actuator 470 may include a worm screw mechanism as shown for engaging a series of slots 475 or teeth operatively coupled to or formed as part of the magnet holding plate 450. In an example embodiment, the positioning actuator 470 may be operatively coupled to an adjustment screw 480 or adjustment knob or dial. In the example embodiment, rotation of the adjustment screw 480 will cause lateral actuation of the magnet holding plate 450. In this way a user is provided the ability to fine tune the position of the magnet holding plate 450 and thus to fine tune the key press force required to be overcome magnetic force on the key caps as described. In an embodiment, the adjustment screw or knob could be hidden to avoid inadvertent adjustments. For example, the adjustment screw 480 or adjustment knob or dial may be located hiding under a cover such as in a battery compartment or other compartment. In other embodiments, the adjustment screw 480 or other adjustment mechanism may be located at an accessible place on the user-configurable keyboard for easy access.

Other example positioning adjustment actuators 470 are contemplated as well. For example, positioning adjustment actuator 470 may be a rack and pinion system to engage the magnet holding tray 450. In another embodiment, a small dc motor or other electromechanical motor may be employed as a positioning adjustment actuator 470 and operatively connected to the magnet holding plate 450 to drive movement. With an electromechanical motor as positioning adjustment actuator 470, magnet holding plate movement may be controlled via a software interface executing instructions on a processor or operating a controller for the electromechanical motor. Key typing feel may therefore be adjusted via settings in the software via a software interface or via operating system settings. Software or firmware may operate via execution of instructions on a processor or controller. The software interface may present a graphical user interface to a user to input typing feel settings. A displayed slide, dial, data entry field level, or other input option may be presented to a user to adjust typing stiffness feel level. Upon selection of a setting via the software interface, the instructions may assess a table with corresponding x_{mag} actuation distances or adjustments corresponding to a selected typing feel level selected by the user interface. Then software instructions will execute commands corresponding to actuating the electromechanical motor to adjust the magnet holding plate the selected distance. At this point, the process may end.

In an example embodiment, typing feel may be fine tune adjusted from a softer to a stiffer feel via the software interface, OS settings, or via mechanical rotation of an adjustment screw or other positioning adjustment mechanism 470. The fine tune adjustment will correspond to lateral actuation of the magnet holding plate 450 to position the magnet closer or further from a rocker panel pivot point.

FIG. 5 illustrates an example chart 500 showing force versus stroke of a user-configurable key according to the present embodiments. Along the y-axis 502 is depicted the key press force (F_{key-press}) applied to the user-configurable key. Along the x-axis 504 is shown a stroke distance in millimeters of a typical key press stroke. Legend 506 depicts adjustments of the magnets with respect to x_{mag} as depicted in FIG. 2 or with respect to distance the magnet is from a pivot point of the rocker panel.

As a keystroke begins in the range 508 along the x-axis 504, key press force F_{key-press} press increases until it reaches a peak 510 at which point F_{key-press} overcomes the magnetic force F_{mag} operational on a side of the rocker panel. The key press force decreases as the key stroke proceeds along 515 until it reaches the bottom of the keystroke at 520 whereby the key press force F_{key-press} meets resistance. Several traces are depicted in FIG. 5 with each showing an actuated distance of x_{mag} away from a point at the pivot point of a rocker panel. As is illustrated, the key press force F_{key-press} required to overcome F_{mag} is reduced at peak 510 as the distance x_{mag} is smaller. Thus, as the magnet is closer to the pivot point of the rocker panel (or to the butterfly key support lower joint), the feel of the typing will be softer. Conversely, as the magnet is moved away from the pivot point and x_{mag} is larger, the force is greater at peak 510 and the user-configurable key feel is stiffer. Several example distances are shown in FIG. 5 as depicted in legend 506 for x_{mag}.

FIG. 6 shows an illustrative embodiment of an implementation of information handling system 600 as a general computer system 600 in accordance with at least one embodiment of the present disclosure. The computer system 600 can include a set of instructions that can be executed to cause the computer system to perform any one or more of the methods or computer based functions disclosed herein. The computer system 600 may operate as a standalone device or may be connected, e.g., using a network, to other computer systems or peripheral devices. For example, the computer system 600 may execute software or hardware instructions via a processor such as 602 to present a typing feel adjustment control software interface in accordance with embodiments above to control actuation of a magnet holding plate.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), mobile computing system, a smart phone, a tablet computer, a communications device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video, or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, for example, a central processing unit (CPU), a graphics processing unit (GPU), or both. Moreover, the computer system 600 can include a main memory 604 and a static memory 605 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. Keyboard 612 may include keyboards according to various embodiments described herein. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 605, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A user-configurable keyboard comprising:
a plurality of keys including:
a keycap;
a key support mechanical linkage having at least one hinge;
a rocker panel including a ferromagnetic portion; and
a magnet;
a magnet holding plate slidably disposed along a key support plate for the plurality of keys; and
a magnet holding plate position adjuster for sliding the magnet holding plate to move the magnet with respect to the rocker panel to adjust a key force for a keystroke of each key.

2. The user-configurable keyboard of claim 1, wherein the magnet holding plate position adjuster is a worm screw.

3. The user-configurable keyboard of claim 1, wherein the magnet holding plate position adjuster is adjusted via turning an adjustment screw operatively connected to the magnet holding plate position adjuster.

4. The user-configurable keyboard of claim 1, wherein the magnet holding plate position adjuster is an electromechanical motor operatively coupled to the magnet holding plate.

5. The user-configurable keyboard of claim 4 further comprising:
a software interface for control of adjustment of the magnet holding plate position via the electromechanical motor to set the typing feel of the user-configurable keys.

6. The user-configurable keyboard of claim 1, wherein the rocker panel is a ferromagnetic strip having an obtuse angle about a pivot point of the rocker panel.

7. The user-configurable keyboard of claim 1, wherein the key support mechanical linkage is a butterfly linkage having at least one hinge disposed between the key cap and a key support plate.

8. A user-configurable key comprising:
a key support mechanical linkage having at least one hinge mounted to a key support surface;
a rocker panel operatively coupled to the key support mechanical linkage and including a ferromagnetic portion;
a magnet;
a magnet holding plate slidably disposed along the key support surface; and
a magnet holding plate position adjuster for sliding the magnet holding plate to move the magnet with respect to a pivot of the rocker panel.

9. The user-configurable key of claim 8, wherein the magnet holding plate position adjuster is a worm screw.

10. The user-configurable key of claim 8, wherein the magnet holding plate position adjuster is a rack and pinion actuator.

11. The user-configurable key of claim 8, wherein the magnet holding plate position adjuster is an electromechanical motor operatively coupled to the magnet holding plate.

12. The user user-configurable key of claim 11 further comprising:
a software interface for control of adjustment of the magnet holding plate position via the electromechanical motor.

13. The user-configurable key of claim 8, wherein the key support mechanical linkage is a butterfly linkage disposed between the key cap and a key support plate.

14. The user-configurable key of claim 8, wherein the key support mechanical linkage is a scissor linkage disposed between the key cap and a key support plate.

15. A keyboard comprising:
a plurality of keys including:
a keycap;
a key support mechanical linkage having at least one hinge;
a rocker panel operatively coupled to the key support mechanical linkage and including a ferromagnetic portion,
a magnet holding plate slidably disposed along a key support plate, the key support plate to support the plurality of keys;
a plurality of magnets disposed under the plurality of keys; and
a magnet holding plate position adjuster for sliding the magnet holding plate to move the magnets with respect to the rocker panels to adjust a key force for the plurality of keys.

16. The keyboard of claim 15, wherein the magnet holding plate position adjuster is an electromechanical motor operatively coupled to the magnet holding plate.

17. The keyboard of claim 15 further comprising:
a software interface for control of adjustment of the magnet holding plate position via the electromechanical motor.

18. The keyboard of claim 15, wherein the magnet holding plate position adjuster is a rack and pinion actuator.

19. The keyboard of claim 15, wherein the keyboard includes retractable keys.

20. The keyboard of claim 19, wherein the magnets are slidably moved across a pivot point of the rocker panel such that a second side of the rocker panel compresses the key support mechanical linkage to retract the keys.
